(19) United States
(12) Patent Application Publication
(10) Pub. No.: US 2019/0165923 A1
(43) Pub. Date: May 30, 2019

(54) METHOD OF DATA TRANSMISSION IN HALF DUPLEX CHANNEL FOR INTERNET PROTOCOL APPLICATIONS

(71) Applicant: VIETTEL GROUP, Ha Noi City (VN)

(72) Inventors: Hoang Anh Nguyen, Ha Noi City (VN); Viet Hoang Nguyen, Ha Noi City (VN); Thai Binh Nguyen, Ha Noi City (VN)

(73) Assignee: VIETTEL GROUP, Ha Noi City (VN)

(21) Appl. No.: 16/198,822

(22) Filed: Nov. 22, 2018

(30) Foreign Application Priority Data
Nov. 24, 2017 (VN) 1-2017-04706

(51) Int. Cl. H04L 5/16; H04L 12/26; H04L 29/12; H04L 29/06

(52) U.S. Cl. CPC H04L 5/16; H04L 69/16; H04L 61/2007; H04L 43/028

(57) ABSTRACT

A new method to transmit data of IP applications over half-duplex channel. More precisely, this method makes it possible to run IP applications (such as e-mail, web . . . ) based on low speed, half-duplex channel (VHF, HF . . . ).

### BACKGROUND OF THE INVENTION

IP based applications are based on the TCP/IP model, a cut-off version of the OSI model.

According to FIG. 1, a Client such as: Web Browser, Mail Client, will communicate directly with a Server like Web Server, Mail Server with a lot of handshake, authentication and data packets. However, this operation mechanism is only suitable for high-speed full-duplex connection like Ethernet (1000BASE-T) or Wi-Fi (802.11), . . . . It is impossible to implement that mechanism on low-speed half duplex connections like Radio HF (7500-9600 bps) or VHF (maximum 19200 bps) because of following reasons:

Firstly, because a half-duplex connection is much slower than a full-duplex one (1, 2 kbps versus 1 Gbps), it slows down transmit/receive packet progress, leading to IP application interruption in the middle.

Secondly, communication process has to switch between transmit and receive phase many times and consecutively for each millisecond, meanwhile the changing time in low-speed half duplex connection is not as fast (for each seconds), so communication cannot be done.

To solve this problem, this invention points out a brand new effective method, which allows IP based application to operate in harsher (low-speed, high noise, simple mode . . . ) and further (up to thousand kilometers) environments with just simple device infrastructure. For example, communication on Radio HF connection only needs two Radio transceivers, but distance can vary up to hundreds or thousand of kilometers, depending on transmit power.

### SUMMARY OF THE INVENTION

Data transmission method for IP applications over half-duplex method includes the below steps: collecting packets from a Data link layer of source IP application; unpacking and filtering packets; automatic communication with source IP application; sending data over half-duplex channel; unpacking and filtering packets; sending packets to Data link layer of the destination system.

### KEY TECHNICAL FEATURES

This invention's purpose is to offers a brand new method, incorporated with conventional communication mechanism between IP based applications to allow it to be operable on low-speed half-duplex connection.

To achieve above purpose, the method is split into 7 steps:
STEP. 1 Receives packets that are sent from the Data link layer of the source IP based application.
STEP. 2 Depacketizes, analyzes and filters packet in source system
STEP. 3 Automatically queries and responses in the source system
STEP. 4 Send data through half-duplex connection.
STEP. 5 Depacketizes, analyzes packet in the destination system.
STEP. 6 Automatically queries and responses in the destination system.
STEP. 7 Send the packets in step 6 to the Link Layer of the destination IP base application.

In this invention, the transmitting/receiving packets at the Link Layer of the wired network protocol (Ethernet) are not transmitting/receiving with physical connection such as 1000BASE-T anymore, and instead are transmitting/receiving with the Virtual Network Interface, and software here only acts as a forwarder between the Link Layer and IPoHD-IP over half-duplex.

Compared with the conventional method of delivering IP applications, this invention provides a software method for obtaining all the information that the source IP application wants to send to the destination IP application by pretending to be a destination IP application and automatically queries and responses, then sends packets via half-duplex connection to the destination system. At the destination system we also have a counterfeit software that receives data, analyzes and then communicates with the destination IP application via automatic queries and responses. According to this mechanism, the source and destination IP applications will not recognize the existence of the intermediate switch component but still operate normally as if they are communicating directly with each other.

This invention allows reliable, stable data transmission, and it can support all types of IP-based applications, which are commonly used on high-speed full-duplex with fast response time and timeout as short as wired network (Ethernet—1000BASE-T), wireless network (Wi-Fi—802.11), . . . .

The invention is based on a combination of a packet collection method at the Link Layer of the TCP/IP, processing, filtering and automatically querying/response mechanism in the same way as IP based application.

### BRIEF DESCRIPTION OF THE DRAWINGS

FIG. 1 is block diagram of TCP/IP protocol to transmitting data over Ethernet.

FIG. 2 is block diagram of new data transmission method that transmits packet over half-duplex channel

FIG. 3 illustrates data structure of TCP/IP protocol.

FIG. 4 illustrates data structure of new transmission method.

FIG. 5 illustrates data transmission sequence of SMTP protocol between Mail Client and IPoHD application.

### DETAILED DESCRIPTION OF THE PREFERRED EMBODIMENT

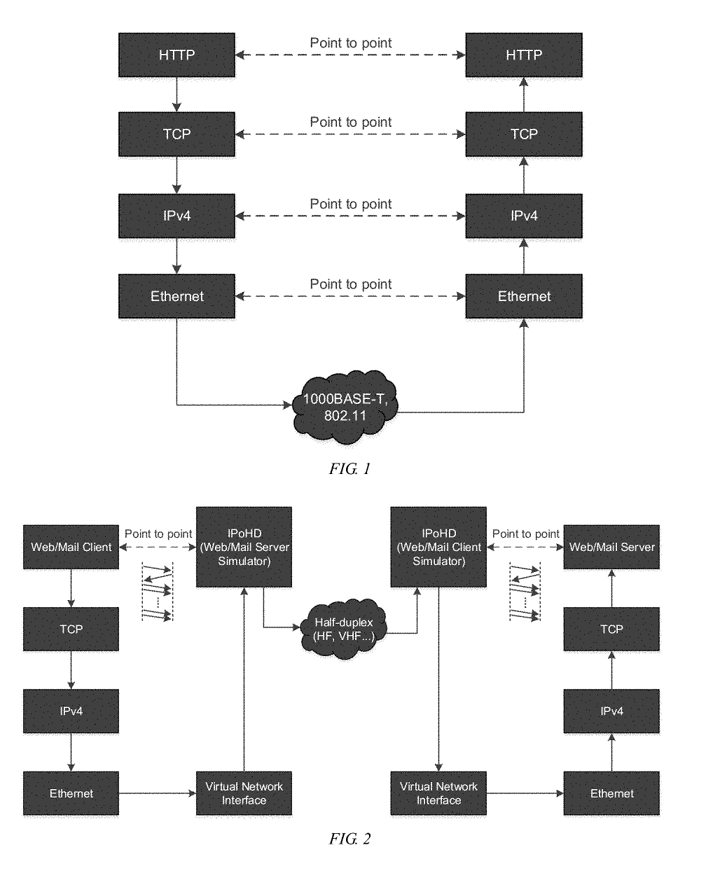

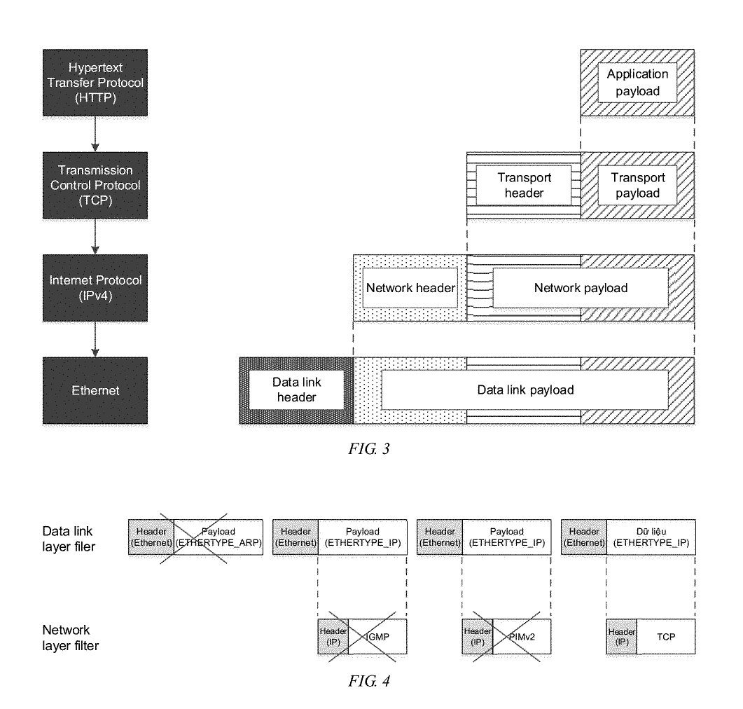

According to FIG. 2, this invention introduces a software solution named as IPoHD to record all data which source IP application (Web Browser, Mail Client . . . ) sends out by pretending to be destination IP application (Web Server, Mail Server). IPoHD queries and responses automatically with the source IP application to get all data to sent. After that, IPoHD sends data over the haft-duplex channel to the destination IP application. In the destination system, IPoHD application receives data from the half-duplex channel and plays the role of source IP application to automatic queries and responses with the destination application. Source and destination IP application are sending IP packets to the IPoHD applications instead of sending out by Ethernet. More precisely, this algorithm includes following steps:

STEP. 1 Collecting IP packet of source IP application from Data link layer of source system.

In order to collect IP packets from Source IP application, IPoHD system uses a Virtual network interface.

This interface forwards all IP packets that are sent to Data Link layer by applications to IPoHD software.

STEP. 2 Unpacking and Filtering packets in source system.

As described in FIG. 4, IPoHD application unpacks IP packets to get information about their protocol stack TCP/IP (MAC Address, IP Address, protocol in each layer . . . ). After that, IPoHD filters IP packets based on their protocol. Packets that pass this filter are transmitted to next step.

STEP. 3 Automatically communicate and collect IP packets from source IP application.

IPoHD has many processing modules to correspond with different applications: HTTP, SMTP, POP3, FTP . . . Packets, that pass over the filter of IPoHD application, are moved to corresponding processing module based on their Transport layer and Application layer protocol.

For example, normally, to send an e-mail, there are many packets that are transmitted between Mail Client and Mail Server to handshake, authenticate, transmit e-mail content and close session.

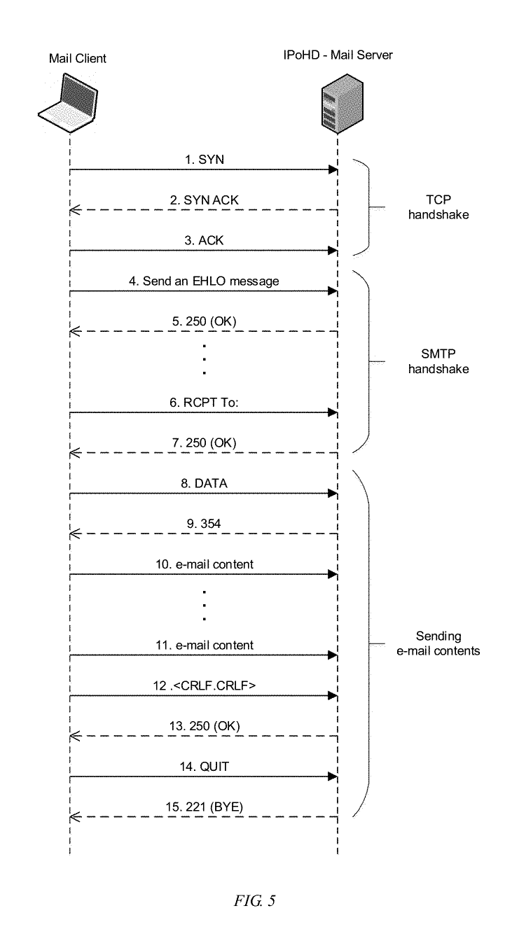

However, with the new solution, IPoHD application pretends to be destination IP application at source system and acts like the source IP application at destination system. By this way, IPoHD application can collect all data that IP applications send. FIG. 5 illustrates data transmission sequence of SMTP protocol between Mail Client and IPoHD application.

STEP. 4 Sending data over half-duplex channel

Data, that are collected after STEP. 3 are sent to the destination system over half-duplex by IPoHD application.

STEP. 5 Unpacking and classifying packets at destination system.

IPoHD application at destination system receives packets from the half-duplex channel, unpacks and classifies them to corresponding processing module based on their protocol (SMTP, HTTP, FTP . . . )

STEP. 6 Automatic communication with destination IP application.

In each processing module, IPoHD application sends IP packets to destination IP application by the way of source IP application sent to IPoHD in the source system. By this way, destination IP application receives all data completely. In the sending e-mail example, this data includes account information, password, and e-mail contents.

STEP. 7 Sending IP packets to destination IP application.

IPoHD using Virtual Network Interface to send packets to Data link layer of TCP/IP protocol stack in the destination system.

By the disclosed system and methods, IP based applications are able to operate in harsher environments (low-speed, high noise, simple mode . . . ) and longer distance environments (up to thousand kilometers).

What is claimed is:

1. A data transmission method for IP applications over half-duplex channel comprising the steps of:
STEP. 1 Receive packets from Data link layer of a source IP application using a virtual network software interface to receive ethernet packets information and then fully transmitting the received ethernet packets information to an IPoHD software;
STEP. 2 Separate, analyze and filter packets in a source system by the IPoHD software separating and analyzing the ethernet packets to get information of each layer in a TCP/IP protocol then deciding which packets will be further processed and which will be discarded based on a supported service;
STEP. 3 For the Ethernet packets passing through the filter step, Automatically enquire and answer at the source system by analyzing a packet to find out which application and protocol it comes from and then passing the packet to a suitable processing module, the IPoHD software comprises multiple processing modules suitable for different applications (HTTP, SMTP, POP3, FTP, . . . ), when a filtered ethernet packet is received, the IPoHD sends a reply message based on a current state and then moves onto a next state in the processing module;
STEP. 4 Send data over a half-duplex transmission line, in this step, received data after the enquire and answer procedure will be wrapped and sent to a destination system over a half-duplex transmission line;
STEP. 5 Separate and analyze packet in the destination system, in this step, the destination system also has an IPoHD to receive and analyze the packet over the half-duplex line; from this point, the application will know which application these packets come from to pass them through a suitable processing module;
STEP. 6 Automatically enquire and answer at the destination system, in this step, processing module correlative with different applications will get received packets communication with a destination IP application through the steps and procedure corresponding to step 3; and
STEP. 7 Send the packet need sending to the destination IP application in step 6 to Data link layer, in this step, IPoHD software in the destination system communicates with the destination IP application going through the virtual network software interface, then the packets are passed to link layer and protocol layers of TCP/IP protocol before lastly reaching the destination IP application.

2. The data transmission method for applications on IP platform over half-duplex transmission line according to claim 1 further has send/receive packets in Data link layer; the ethernet protocol do not send/receive with physical transmission line such as 1000BASE-T, instead send and receive with the virtual network software interface which takes part in passing packets between link layer and IPoHD-IP over half-duplex software.

3. The data transmission method for application on IP platform over half-duplex transmission line according to claim 1, including:
getting all the data that the source IP application want to sent to the destination IP application by pretending to be the destination IP application to automatically enquire and answer, then sending over low-speed half-duplex transmission line to destination system;
IPoHD in destination system also pretend to be the source IP application to receive and analyze data then communicate with the destination IP application through an automatic enquire and answer procedure where source and destination IP application will not see transmission agent components but still can normally communicate like in the case where they directly transmit to each other.

4. The data transmission method for application on IP platform over half-duplex transmission line according to claim 1, including:
Allowing steady and reliable data transmission, supporting all IP applications, which are applications usually transmitted over high-speed full-duplex transmission line, fast respond and short timeout similar ethernet—1000BASE-T or wifi—802.11.

5. The data transmission method for application on IP platform over half-duplex transmission line according to claim 1, comprising:
The combination of TCP/IP protocol Data link layer data collecting method, automatic enquire/answer and packet processing and filtering procedure for application on IP platform.
